(19) United States
(12) Patent Application Publication
(10) Pub. No.: US 2014/0138965 A1
(43) Pub. Date: May 22, 2014

(54) BUMPER REINFORCEMENT

(71) Applicants: Aisin Keikinzoku Kabushiki Kaisha, Imizu-shi (JP); Aisin Seiki Kabushiki Kaisha, Kariya-shi (JP)

(72) Inventors: Takanobu Kaneko, Kariya-shi (JP); Kiyoichi Kita, Imizu-shi (JP)

(73) Assignees: AISIN KEIKINZOKU KABUSHIKI KAISHA, Imizu-shi (JP); AISIN SEIKI KABUSHIKI KAISHA, Kariya-shi (JP)

(21) Appl. No.: 14/082,698

(22) Filed: Nov. 18, 2013

(30) Foreign Application Priority Data
Nov. 21, 2012 (JP) 2012-254932

(51) Int. Cl. B60R 19/18

(52) U.S. Cl. CPC B60R 19/18; B60R 2019/1826
USPC 293/148

(57) ABSTRACT

A bumper reinforcement formed by bending a sheet of a belt-shaped metal plate along a longitudinal direction of the metal plate and mounted to a vehicle body includes a first tubular portion and a second tubular portion both formed in a tubular shape by bending the metal plate along the longitudinal direction of the metal plate and a connecting portion formed by bending a middle portion in a width direction of the metal plate along the longitudinal direction of the metal plate. The middle portion is positioned between portions where the first tubular portion and the second tubular portion are formed. The connecting portion connects the first and second tubular portions and includes a first folding portion sandwiching a first end portion in the width direction of the metal plate and a second folding portion sandwiching a second end portion in the width direction of the metal plate.

### CROSS REFERENCE TO RELATED APPLICATIONS

This application is based on and claims priority under 35 U.S.C. §119 to Japanese Patent Application 2012-254932, filed on Nov. 21, 2012, the entire content of which is incorporated herein by reference.

### TECHNICAL FIELD

This disclosure generally relates to a bumper reinforcement.

### BACKGROUND DISCUSSION

Known bumper reinforcements formed by bending a belt-shaped metal plate are disclosed in JP2010-507532A (hereinafter referred to as Patent reference 1) and JP2001-260774A (hereinafter referred to as Patent reference 2). According to Patent reference 1 and Patent reference 2, a cross-section perpendicular to a longitudinal direction of the bumper reinforcement is formed in a B-shape. The longitudinal direction of the bumper reinforcement corresponds to a vehicle width direction when the bumper reinforcement is mounted to a vehicle. The bumper reinforcement disclosed in Patent reference 1 and Patent reference 2 corresponds to two tubular portions extending in the vehicle width direction and includes the two tubular portions and a connecting portion. The two tubular portions are mounted in parallel to a vehicle height direction, that is, the two tubular portions are mounted in an up-down direction. The connecting portion connects the two tubular portions. The cross-section of the tubular portion perpendicular to the vehicle width direction is formed in a substantially square-shape. The connecting portion disclosed in Patent reference and Patent reference 2 includes a front connecting wall portion and a rear connecting wall portion. The front connecting wall portion connects each front wall portion of the two tubular portions. The rear connecting wall portion connects a front end portion of a bottom wall portion of the tubular portion arranged at an upper of the two tubular portions and a front end portion of a top wall portion of the tubular portion arranged at a lower of the two tubular portions.

According to the bumper reinforcement disclosed in Patent reference 1, the front connecting wall portion and the rear connecting wall portion are welded. Accordingly, it takes time to weld the front connecting wall portion and the rear connecting wall portion, resulting in low production efficiency.

According to Patent reference 2, the bumper reinforcement includes a recessed portion arranged at a center portion of the rear connecting wall portion in the vehicle height direction and a protrusion arranged at a center portion of the front connecting wall portion in the vehicle height direction. The recessed portion and the protrusion are joined, or bonded by recess-projection fitting. According to the bumper reinforcement disclosed in Patent reference 2, the production efficiency is increased because the welding process performed to another known bumper reinforcement as disclosed in Patent reference 1 is not needed. However, when an impact or a shock is applied to the bumper reinforcement disclosed in Patent reference 2, the bumper reinforce has tendency to cause so-called collapse of the cross-section (deformation of the cross-section) because the protrusion and the recessed portion are separated. Thus, strength of the bumper reinforcement disclosed in Patent reference 2 against the impact or the shock tends to be lower than the strength of another known bumper reinforcement as disclosed in Patent reference 1.

A need thus exists for bumper reinforcement which is not susceptible to the drawback mentioned above.

### SUMMARY

According to an aspect of this disclosure, a bumper reinforcement formed by bending a sheet of a belt-shaped metal plate along a longitudinal direction of the metal plate and mounted to a vehicle body includes a first tubular portion formed in a tubular shape by bending the metal plate along the longitudinal direction of the metal plate, a second tubular portion formed in the tubular shape by bending the metal plate along the longitudinal direction of the metal plate and a connecting portion formed by bending a middle portion in a width direction of the metal plate along the longitudinal direction of the metal plate. The middle portion is positioned between portions where the first tubular portion and the second tubular portion are formed. The connecting portion connects the first tubular portion and the second tubular portion and includes a first folding portion sandwiching a first end portion in the width direction of the metal plate and a second folding portion sandwiching a second end portion in the width direction of the metal plate.

### BRIEF DESCRIPTION OF THE DRAWINGS

The foregoing and additional features and characteristics of this disclosure will become more apparent from the following detailed description considered with the reference to the accompanying drawings, wherein:

FIG. 1A is a perspective view of a bumper reinforcement viewed from obliquely frontward according to a first embodiment disclosed here;

FIG. 1B is a perspective view of the bumper reinforcement illustrated in FIG. 1A viewed from obliquely rearward according to the first embodiment;

FIG. 2 is a side view of the bumper reinforcement illustrated in FIG. 1 according to the first embodiment;

FIG. 3 is an enlarged view of a connecting portion of the bumper reinforcement illustrated in FIG. 2 according to the first embodiment.

FIG. 4 is an enlarged view of a connecting portion of a bumper reinforcement according to a second embodiment.

FIG. 5 is an enlarged view of a connecting portion of a bumper reinforcement according to a third embodiment.

FIG. 6 is an enlarged view of a connecting portion of a bumper reinforcement according to a fourth embodiment.

### DETAILED DESCRIPTION

A bumper reinforcement 10 according to a first embodiment of the disclosure will be described. The bumper reinforcement 10 is mounted to a vehicle body (for example, a side member) via a supporting member (for example a crush box). The bumper reinforcement 10 is mounted to the vehicle body such that a longitudinal direction of the bumper reinforcement 10 accords with a vehicle width direction. Further, according to the first embodiment, the bumper reinforcement 10 is described as a member mounted to a front end portion of the vehicle. However, the disclosure is applicable to a case where the bumper reinforcement 10 is mounted to a rear end portion of the vehicle.

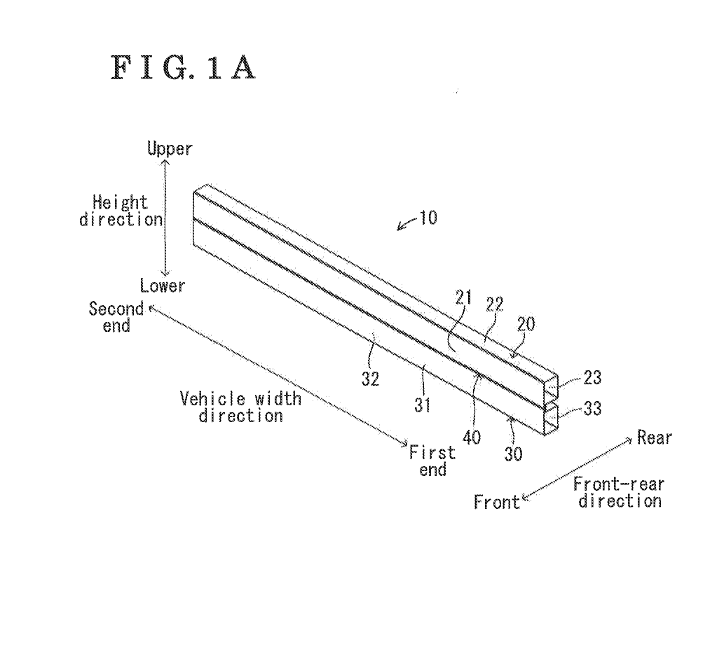

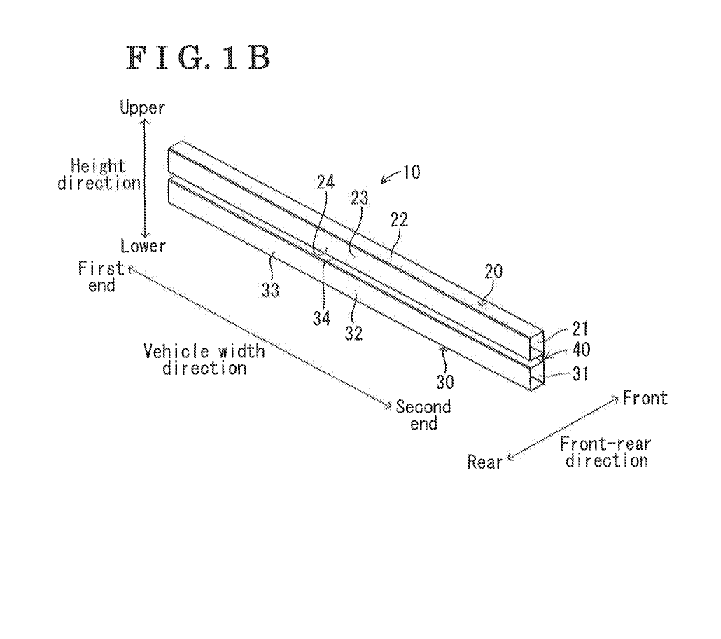

As illustrated in FIGS. 1A and 1B, the bumper reinforcement 10 corresponds to two tubular portions extending in the vehicle width direction and includes an upper tubular portion 20 (serving as a first tubular portion) arranged at an upper in a vehicle height direction and a lower tubular portion 30 (serving as a second tubular portion) arranged at a lower in the vehicle height direction. The upper tubular portion 20 and the lower tubular portion 30 are connected via a connecting portion 40. The upper tubular portion 20, the lower tubular portion 30 and the connecting portion 40 are integrally formed by bending a sheet of belt-shaped metal plate P (for example, by roll-forming). Considering the formability (flexibility) of the metal plate P and the strength of the bumper reinforcement 10 against an impact or a shock, a material which has a yield strength of equal to or greater than 980 MPa and equal to or less than 1470 MPa is favorably selected as the metal plate P.

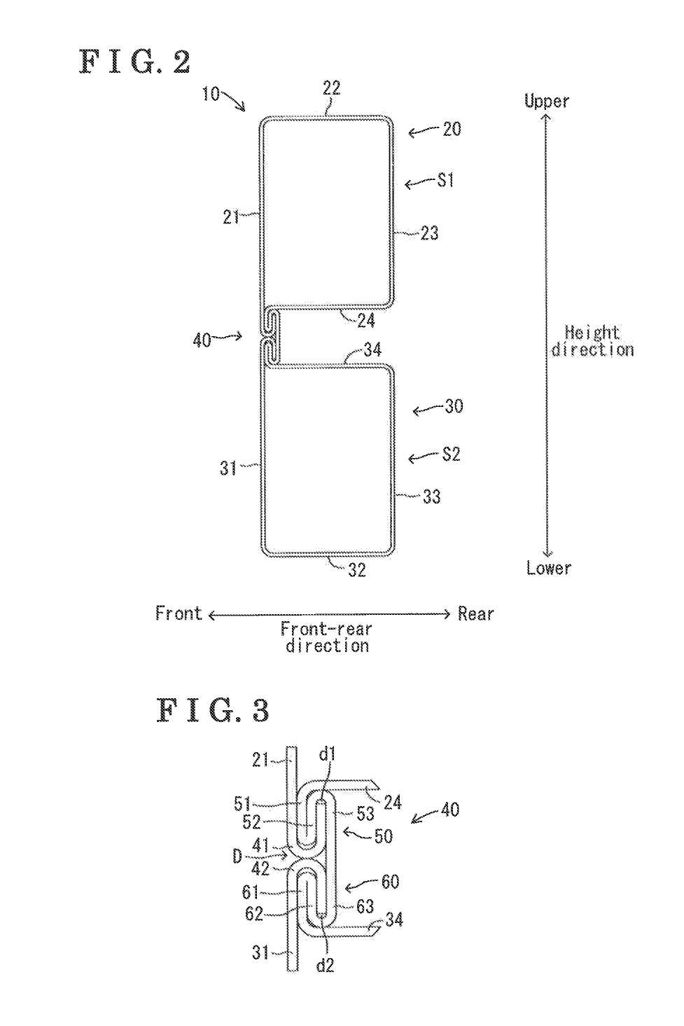

The upper tubular portion 20 is formed by bending plural portions positioned between a first end portion 41 and a middle portion in the width direction of the metal plate P along the longitudinal direction to form a clearance inside the upper tubular portion 20. The lower tubular portion 30 is formed by bending plural portions positioned between a second end portion 42 and the middle portion in the width direction of the metal plate P along the longitudinal direction to form a clearance inside the lower tubular portion 30. As illustrated in FIG. 2, the upper tubular portion 20 includes a first front wall portion 21, a first top wall portion 22, a first rear wall portion 23 and a first bottom wall portion 24. The first front wall portion 21 is perpendicular to a vehicle front-rear direction in a state where the bumper reinforcement 10 is mounted to the front end portion of the vehicle. The first top wall portion 22 extends from a top end of the first front wall portion 21 to rearward. The first rear wall portion 23 extends from a rear end of the first top wall portion 22 to downward. The first bottom wall portion 24 extends from a bottom end of the first rear wall portion 23 to frontward. A front end of the first bottom wall portion 24 is in contact with a rear surface of the first front wall portion 21. The first front wall portion 21 and the first rear wall portion 23 are arranged in parallel to one another while the first top wall portion 22 and the first bottom wall portion 24 are arranged in parallel to one another. The first top wall portion 22 and the first bottom wall portion 24 are perpendicular to the first front wall portion 21 and the first rear wall portion 23. That is, a cross-section S1 of the upper tubular portion 20 perpendicular to the vehicle width direction is formed in a square shape.

The lower tubular portion 30 is configured similarly to the upper tubular portion 20. That is, the lower tubular portion 30 includes a second front wall portion 31, a second bottom wall portion 32, a second rear wall portion 33 and a second top wall portion 34. The second front wall portion 31 is perpendicular to the vehicle front-rear direction in a state where the bumper reinforcement 10 is mounted to the front end portion of the vehicle. The second bottom wall portion 32 extends from a bottom and of the second front wall portion 31 to rearward. The second rear wall portion 33 extends from a rear end of the second bottom wall portion 32 to upward. The second top wall portion 34 extends from a top end of the second rear wall portion 33 to frontward. A front end of the second top wall portion 34 is in contact with a rear surface of the second front wall portion 31. The second front wall portion 31 and the second rear wall portion 33 are arranged in parallel to one another while the second top wall portion 34 and the second bottom wall portion 32 are arranged in parallel to one another. The second top wall portion 34 and the second bottom wall portion 32 are perpendicular to the second front wall portion 31 and the second rear wall portion 33. That is, a cross-section S2 of the lower tubular portion 30 perpendicular to the vehicle width direction is formed in a square shape. The cross-sections S1 and S2 have the same shape and size and are arranged at the same position in the vehicle front-rear direction.

As illustrated in FIG. 3, the connecting portion 40 includes the first end portion 41 in a width direction of the metal plate P and the second end portion 42 in the width direction of the metal plate P an upper connecting portion 50 and a lower connecting portion 60. The upper connecting portion 50 and the lower connecting portion 60 are formed by folding, plural times, a portion of the metal plate P (middle portion in the width direction of the metal plate P) positioned between portions where the upper tubular portion 20 and the lower tubular portion 30 are formed. The upper connecting portion 50 includes an upper-front wall portion 51, an upper-middle wall portion 52 (serving as a first folding portion) and an upper rear wall portion 53 (serving as a first folding portion). The upper-front wall portion 51 extends from the front end of the first bottom wall portion 24 to downward. The upper-middle wall portion 52 is folded from a bottom end of the upper-front wall portion 51 to rear of the upper-front wall portion 51 and extends upward. The upper-rear wall portion 53 is folded from a top end of the upper-middle wall portion 52 to rear of the upper-middle wall portion 52 and extends downward. At the stage immediately after the upper-middle wall portion 52 and the upper-rear wall portion 53 are formed by bending, a clearance d1 is formed between the upper-middle wall portion 52 and the upper-rear wall portion 53 and extends in the vehicle width direction. A width of the clearance d1 in the vehicle front-rear direction is slightly wider than a plate-thickness of the metal plate P. According to the first embodiment, a portion extending from a lower portion of the first front wall portion 21 to downward corresponds to a first end portion 41 in the width direction of the metal plate P while a portion extending from an upper portion of the second front wall portion 31 to upward corresponds to a second end portion 42 in the width direction of the metal plate P. According to the disclosure, the upper-middle wall portion 52 and the upper-rear wall portion 53 correspond to folding portions.

The lower connecting portion 60 includes a lower-front wall portion 61, a lower-middle wall portion 62 (serving as a second folding portion), and a lower-rear wall portion 63 (serving as a second folding portion). The lower-front wall portion 61 extends from a front end of the second top wall portion 34 to upward. The lower-middle wall portion 62 is folded from a top and of the lower-front wall portion 61 to rear of the lower-front wall portion 61 and extends downward. The lower-rear wall portion 63 is folded from a bottom end portion of the lower-middle wall portion 62 to rear of the lower-middle wall portion 62 and extends upward. At the stage immediately after the lower-middle wall portion 62 and the lower-rear wall portion 63 are formed by bending, a clearance d2 is formed between the lower-middle wall portion 62 and the lower-rear wall portion 63 and extends in the vehicle width direction. A width of the clearance d2 in the vehicle front-rear direction is slightly wider than the plate thickness of the metal plate P. According to the disclosure, the lower-middle wall portion 62 and the lower-rear wall portion 63 correspond to the folding portions.

An upper end portion of the lower-rear wall portion 63 corresponds to a portion extended from a lower portion of the upper-rear wall portion 53 to downward (The upper end portion of the lower-rear wall portion 63 and the lower end portion of the upper-rear wall portion 53 are connected). Lower ends of the upper-front wall portion 51 and the upper-middle wall portion 52 are arranged slightly upper than a center position in the height direction of the bumper reinforcement 10. On the contrary, upper ends of the lower-front wall portion 61 and the lower-middle wall portion 62 are arranged slightly lower than the center position in the height direction of the bumper reinforcement 10. Accordingly, a clearance D is formed between lower ends of the upper-front wall portion 51 and the upper-middle wall portion 52 and upper ends of the lower-front wall portion 61 and the lower-middle wall portion 62 and extends in the vehicle width direction. A width of the clearance D in the vehicle height direction is narrow. The first end portion 41 in the width direction of the metal plate P is folded at the center position in the height direction of the bumper reinforcement 10 to rearward and inserted to be positioned in the clearance d1 via the clearance D. The second end portion 42 in the width direction of the metal plate P is folded at the center position in the height direction of the bumper reinforcement 10 to rearward and inserted to be positioned in the clearance d2 via the clearance D. In a state where the first end portion 41 in the width direction of the metal plate P is inserted to be positioned in the clearance d1 and the second end portion 42 in the width direction of the metal plate P is inserted to be positioned in the clearance d2, a pressing element is applied to contact with a front surface of the connecting portion 40 (front surfaces of the first end portion 41 and the second and portion 42) and a rear surface of the connecting portion 40 (rear surfaces of the upper-rear wall portion 53 and the lower-rear wall portion 63) to sandwich and press the connecting portion 40. Accordingly, the upper-middle wall portion 52 and the upper-rear wall portion 53 as well as the lower-middle wall portion 62 and the lower-rear wall portion 63 are crimped. That is, the upper-middle wall portion 52, the upper-rear wall portion 53, the lower-middle wall portion 62 and the lower-rear wall portion 63 are deformed to narrow the widths of the clearances dl and d2 in the vehicle front-rear direction. Thus, the first end portion 41 in the width direction of the metal plate P is in close contact with the upper-middle wall portion 52 and the upper-rear wall portion 53 while the second end portion 42 in the width direction of the metal plate P is in close contact with the lower-middle wall portion 62 and the lower-rear wall portion 63. As described above, the first end portion 41 in the width direction of the metal plate P is joined, or bonded to the upper connecting portion 50 while the second end portion 42 in the width direction of the metal plate P is joined, or bonded to the lower connecting portion 60.

According to the bumper reinforcement 10 configured as above, in a state where the first end portion 41 in the width direction of the metal plate P is inserted to be positioned in the clearance d1 of the upper connecting portion 50 while the second end portion 42 in the width direction of the metal plate P is inserted to be positioned in the clearance d2 of the lower connecting portion 60, the upper-middle wall portion 52 and the upper-rear wall portion 53 as well as the lower-middle wall portion 62 and the lower-rear wall portion 63 are crimped. Accordingly, the first end portion 41 in the width direction of the metal plate P is joined, or bonded to the upper connecting portion 50 while the second end portion 42 in the width direction of the metal plate P is joined, or bonded to the lower connecting portion 60. According to the first embodiment, because a welding process performed to the known bumper reinforcement that needs the welding process is not needed, the production efficiency of the bumper reinforcement 10 is higher than the known bumper reinforcement that needs the welding process. Further, because the first end portion 41 in the width direction of the metal plate P is sandwiched by the upper-middle wall portion 52 and the upper-rear wall portion 53 while the second end portion 42 in the width direction of the metal plate P is sandwiched by the lower-middle wall portion 62 and the lower-rear wall portion 63, the first end portion 41 in the width direction of the metal plate P and the second end portion 42 in the width direction of the metal plate P are hardly separated from the upper connecting portion 50 and the lower connecting portion 60, respectively, even if the impact or the shock is applied to the bumper reinforcement 10.

In particular, when the impact is applied from a front of the bumper reinforcement 10 illustrated in FIG. 2, the upper tubular portion 20 has a tendency to pivot about the connecting portion 40 in a clockwise direction while the lower tubular portion 30 has a tendency to pivot about the connecting portion 40 in a counter-clockwise direction. Then, the upper-front wall portion 51 and the upper-middle wall portion 52 have a tendency to move upward while the lower-front wall portion 61 and the lower-middle wall portion 62 have a tendency to move downward. The upper end portion of the upper-middle wall portion 52 is folded to connect with the upper-rear wall portion 53 while the lower end portion of the lower-middle wall portion 62 is folded to connect with the lower-rear wall portion 63. Further, the lower end portion of the upper-rear wall portion 53 and the upper end portion of the lower-rear wall portion 63 are connected. Accordingly, the upper-front wall portion 51 and the upper-middle wall portion 52 are restricted from moving upward while the lower-front wall portion 61 and the lower-middle wall portion 62 are restricted from moving downward. Thus, compared to the known bumper reinforcement, collapse of the cross-section (deformation of the cross-section) of the bumper reinforcement 10 in the collision of the vehicle is reduced. That is, the bumper reinforcement 10 has a higher strength than the known bumper reinforcement against the impact.

Constructions of the bumper reinforcement are not limited to the aforementioned embodiment and various modifications are applied as long as the modifications do not depart from the objective of the disclosure.

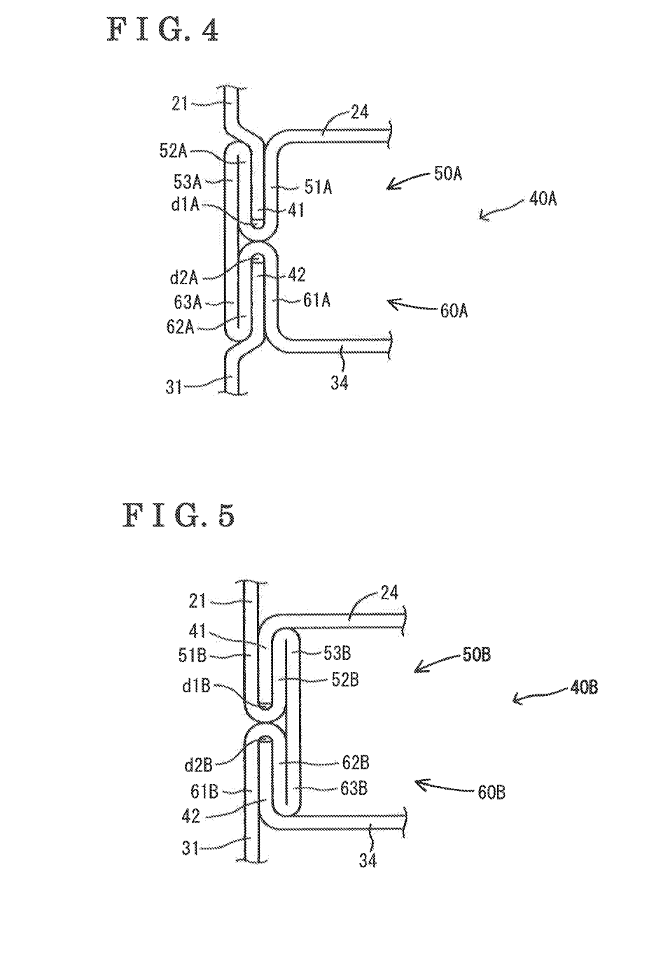

Constructions of the second embodiment will be described as follows. For example, the connecting portion 40 of the aforementioned embodiment may be modified to a connecting portion 40A illustrated in FIG. 4 as a second embodiment. As other constructions are the same as in the first embodiment, redundant description will not be repeated. The connecting portion 40A of the second embodiment includes the first end portion 41 in the width direction of the metal plate P and the second end portion 42 in the width direction of the metal plate P, an upper connecting portion 50A and a lower connecting portion 60A. The upper connecting portion 50A includes an upper-rear wall portion 51A (serving as a first folding portion), an upper-middle wall portion 52A (serving as a first folding portion) and an upper-front wall portion 53A. The upper-rear wall portion 51A extends from a front end portion of the first bottom wall portion 24 to downward. The upper-middle wall portion 52A is folded from a lower end portion of the upper-rear wall portion 51A to front of the upper-rear wall portion 51A and extends upward. The upper-front wall portion 53A is folded from an upper end portion of the upper-middle wall portion 52A to front of the upper-middle wall portion 52A and extends downward. At the stage immediately after the upper-middle wall portion 52A and the upper-rear wall portion 51A are formed by bending, a clearance d1A is formed between the upper-middle wall portion 52A and the upper-rear wall portion 51A and extends in the vehicle width direction. A width of the clearance d1A in the vehicle front-rear direction is slightly wider than the plate-thickness of the metal plate P. According to the disclosure, the upper-middle wall portion 52A and the upper-rear wall portion 51A correspond to the folding portions.

As illustrated in FIG. 4, the lower connecting portion 60A includes a lower-rear wall portion 61A (serving as a second folding portion), a lower-middle wall portion 62A (serving as a second folding portion) and a lower-front wall portion 63A. The lower-rear wall portion 61A extends from a front end portion of the second top wall portion 34 to upward. The lower-middle wall portion 62A is folded from an upper end portion of the lower-rear wall portion 61A to front of the lower-rear wall portion 61A and extends downward. The lower-front wall portion 63A is folded from a lower end portion of the lower-middle wall portion 62A to front of the lower-middle wall portion 62A and extends upward. At the stage immediately after the lower-middle wall portion 62A and the lower-rear wall portion 61A are formed by bending, a clearance d2A is formed between the lower-middle wall portion 62A and the lower-rear wall portion 61A and extends in the vehicle width direction. A width of the clearance d2A in the vehicle front-rear direction is slightly wider than the plate-thickness of the metal plate P. According to the disclosure, the lower-middle wall portion 62A and the lower-rear wall portion 61A correspond to the folding portions.

As illustrated in FIG. 4, an upper end portion of the lower-front wall portion 63A corresponds to a portion extended from a lower portion of the upper-front wall portion 53A to downward (The upper end portion of the lower-front wall portion 63A and the lower end portion of the upper-front wall portion 53A are connected). Lower ends of the upper-rear wall portion 51A and the upper-middle wall portion 52A are arranged at the center position in the height direction of the bumper reinforcement 10. Upper ends of the lower-rear wall portion 61A and the lower-middle wall portion 62A are arranged at the center position in the height direction of the bumper reinforcement 10. The first front wall portion 21 and the first end portion 41 in the width direction of the metal plate P are formed in a stepwise manner, or a substantially stepwise manner to position the first end portion 41 in the width direction of the metal plate P slightly rearward of the first front wall portion 21. Then, the first end portion 41 in the width direction of the metal plate P is inserted to be positioned in the clearance d1A. On the contrary, the second front wall portion 31 and the second end portion 42 in the width direction of the metal plate P are formed in a stepwise manner, or a substantially stepwise manner to position the second end portion 42 in the width direction of the metal plate P slightly rearward of the second front wall portion 31. Then, the second end portion 42 of the metal plate P is inserted to be positioned in the clearance d2A. In a state where the first end portion 41 in the width direction of the metal plate P is inserted to be positioned between the upper-middle wall portion 52A and the upper-rear wall portion 51A while the second and portion 42 in the width direction of the metal plate P is inserted to be positioned between the lower-middle wall portion 62A and the lower-rear wall portion 61A, the front surface and the rear surface of the connecting portion 40A are in contact with the pressing element that sandwiches and presses the connecting portion 40A. Accordingly, the upper-rear wall portion 51A and the upper-middle wall portion 52A as well as the lower-rear wall portion 61A and the lower-middle wall portion 62A are crimped. Thus, the first end portion 41 in the width direction of the metal plate P is joined, or bonded to the upper connecting portion 50A while the second end portion 42 in the width direction of the metal plate P is joined, or bonded to the lower connecting portion 60A. Effects and advantages similar to the aforementioned embodiment may be attained.

Constructions of the third embodiment will be described as follows. For example, the connecting portion 40 of the aforementioned embodiment may be modified to a connecting portion 40B illustrated in FIG. 5 as a third embodiment. As other constructions are the same as in the first embodiment, redundant description will not be repeated. According to the third embodiment, a portion extending from a front end portion of the first bottom wall portion 24 to downward corresponds to the first end portion 41 in the width direction of the metal plate P while a portion extending from a front end portion of the second top wall portion 34 to upward corresponds to the second end portion 42 in the width direction of the metal plate. The connecting portion 40B includes the first end portion 41 in the width direction of the metal plate P and the second end portion 42 in the width direction of the metal plate P, an upper connecting portion 50B and a lower connecting portion 60B. The upper connecting portion 50B includes an upper-front wall portion 51B (serving as a first folding portion), an upper-middle wall portion 52B (serving as a first folding portion), and an upper-rear wall portion 53B. The upper-front wall portion 51B extends from the lower portion of the first front wall portion 21 to downward. The upper-middle wall portion 52B is folded from a lower end portion of the upper-front wall portion 51B to a rear of the upper-front wall portion 51B and extends upward. The upper-rear wall portion 53B is folded from an upper end portion of the upper-middle wall portion 52B to a rear of the upper-middle wall portion 52B and extends downward. At the stage immediately after the upper-front wall portion 51B and the upper-middle wall portion 52B are formed by bending, a clearance d1B is formed between the upper-front wall portion 51B and the upper-middle wall portion 52B and extends in the vehicle width direction. A width of the clearance d1B in the vehicle front-rear direction is slightly wider than the plate-thickness of the metal plate P. According to the disclosure, the upper-front wall portion 51B and the upper-middle wall portion 52B correspond to the folding portion.

As illustrated in FIG. 5, the lower connecting portion 60B includes a lower-front wall portion 61B (serving as a second folding portion), a lower-middle wall portion 62B (serving as a second folding portion), and a lower-rear wall portion 63B. The lower-front wall portion 61B extends from the upper portion of the second front wall portion 31 to upward. The lower-middle wall portion 62B is folded from an upper end portion of the lower-front wall portion 61B to a rear of the lower-front wall portion 61B and extends downward. The lower-rear wall portion 63B is folded from a lower end portion of the lower-middle wall portion 62B to a rear of the lower-middle wall portion 62B and extends upward. At the stage immediately after the lower-front wall portion 61B and the lower-middle wall portion 62B are formed by bending, a clearance d2B is formed between the lower-front wall portion 61B and the lower-middle wall portion 62B and extends in the vehicle width direction. A width of the clearance d2B in the vehicle front-rear direction is slightly wider than the plate-thickness of the metal plate P. According to the disclosure, the lower-front wall portion 61B and the lower-middle wall portion 62B correspond to the folding portions.

As illustrated in FIG. 5, an upper end portion of the lower-rear wall portion 63B corresponds to a portion extended from a lower portion of the upper-rear wall portion 53B to downward (The upper end portion of the lower-rear wall portion 63B and the lower end portion of the upper-rear wall portion 53B are connected). Lower ends of the upper-front wall portion 51B and the upper-middle wall portion 52B are arranged at the center position in the height direction of the bumper reinforcement 10. Upper ends of the lower-front wall portion 61B and the lower-middle wall portion 62B are arranged at the center position in the height direction of the bumper reinforcement 10. The first end portion 41 in the width direction of the metal plate P is inserted to be positioned in the clearance d1B. The second end portion 42 in the width direction of the metal plate P is inserted to be positioned in the clearance d2B. In a state where an end portion of the first bottom wall portion 24 is inserted to be positioned in the clearance d1B while an end portion of the second top wall portion 34 is inserted to be positioned in the clearance d2B, the pressing element is applied to contact with the front surface and the rear surface of the connecting portion 40B to sandwich and press the connecting portion 40B. Accordingly, the upper-front wall portion 51B and the upper-middle wall portion 52B as well as the lower-front wall portion 61B and the lower-middle wall portion 62B are crimped. Thus, the first end portion 41 in the width direction of the metal plate P is joined, or bonded to the upper connecting portion 50B while the second end portion 42 in the width direction of the metal plate P is joined, or bonded to the lower connecting portion 60B. Effects and advantages similar to the aforementioned embodiment may be attained.

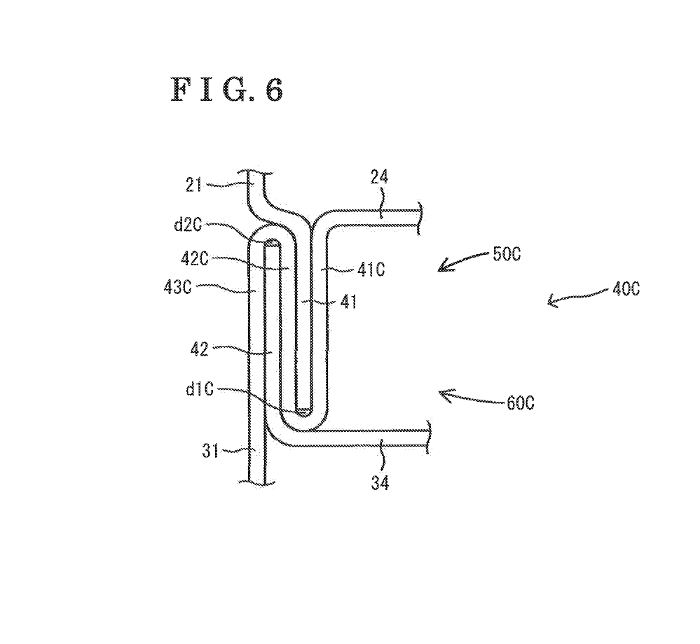

Constructions of the fourth embodiment will be described as follows. For example, the connecting portion 40 of the aforementioned embodiment may be modified to a connecting portion 40C illustrated in FIG. 6 as a fourth embodiment. As other constructions are the same as in the first embodiment, redundant description will not be repeated. According to the fourth embodiment, a portion extending from a lower portion of the first front wall portion 21 to downward corresponds to the first end portion 41 in the width direction of the metal plate P while a portion extending from a front end portion of the second top wall portion 34 to upward corresponds to the second end portion 42. The connecting portion 40C includes the first end portion 41 in the width direction of the metal plate P and the second end portion 42 in the width direction of the metal plate P a rear wall portion 41C (serving as a first folding portion), a middle wall portion 42C (serving as a first folding portion and a second folding portion) and a front wall portion 43C (serving as a second folding portion). The rear wall portion 41C extends from the front end portion of the first bottom wall portion 24 to downward. The middle wall portion 42C is folded from a lower end portion of the rear wall portion 41C to front of the rear wall portion 41C and extends upward. The front wall portion 43C is folded from an upper end portion of the middle wall portion 42C to front of the middle wall portion 42C and extends downward. At the stage immediately after the rear wall portion 41C, the middle wall portion 42C and the front wall portion 43C are formed by bending, clearances d1C and d2C are formed. The clearance d1C is arranged between the rear wall portion 41C and the middle wall portion 42C and extends in the vehicle width direction while the clearance d2C is arranged between the middle wall portion 42C and the front wall portion 43C and extends in the vehicle width direction. Widths of the clearances d1C and d2C in the vehicle front-rear direction are slightly wider than the plate-thickness of the metal plate P. According to the disclosure, the rear wall portion 41C, the middle wall portion 42C and the front wall portion 43C correspond to the folding portions.

As illustrated FIG. 6, a lower end portion of the front wall portion 43C corresponds to a portion extended from an upper portion of the second front wall portion 31 to upward (The lower end portion of the front wall portion 43C and the upper end portion of the second front wall portion 31 are connected). Lower ends of the rear wall portion 41C and the middle wall portion 42C are arranged at a same position as the upper portion of the second top wall portion 34 while upper ends of the middle wall portion 42C and the front wall portion 43C are arranged at a same position as the lower portion of the first bottom wall portion 24. The first front wall portion 21 and the first end portion 41 in the width direction of the metal plate P are formed in a stepwise manner, or a substantially stepwise manner to position the first end portion 41 in the width direction of the metal plate P slightly rearward of the first front wall portion 21. Then, the first end portion 41 in the width direction of the metal plate P is inserted to be positioned inside the clearance d1C. The second end portion 42 in the width direction of the metal plate P is arranged to be positioned inside the clearance d2C. In a state where the first end portion 41 in the width direction of the metal plate P is arranged to be positioned inside the clearance d1C while the second end portion 42 in the width direction of the metal plate P is inserted to be positioned inside the clearance d2C, the pressing element is applied to contact with the front surface and the rear surface of the connecting portion 40C to sandwich and press the connecting portion 40C. Accordingly, the rear wall portion 41C and the middle wall portion 42C as well as the middle wall portion 42C and the front wall portion 43C are crimped to join or bond the first end portion 41 in the width direction of the metal plate P and an upper connecting portion 50C as well as the second end portion 42 in the width direction of the metal plate P and a lower connecting portion 60C. The upper connecting portion 50C is configured with the first end portion 41 in the width direction of the metal plate P, the rear wall portion 41C and the middle wall portion 42C. The rear wall portion 41C extends from the front end of the first bottom wall portion 24 of the upper tubular portion 20 to downward. The lower connecting portion 60C is configured with the second end portion 42 in the width direction of the metal plate P, the middle wall portion 42C and the front wall portion 43C. The second end portion 42 in the width direction of the metal plate P extends from the front end portion of the second top wall portion 34 of the lower tubular portion 30 to upward. Effects and advantages similar to the aforementioned embodiment may be attained.

Further, a cross-section of the upper tubular portion 20 and the lower tubular portion 30 is not limited to the aforementioned embodiment and any shapes are applied. According to the aforementioned embodiment, the cross-sections of upper tubular portion 20 and the lower tubular portion 30 have the same shape and size. Alternatively, the cross-sections of the upper tubular portion 20 and the lower tubular portion 30 may have different shapes and sizes.

According to the aforementioned embodiment, the connecting portion 40 connects the front end portion of the first bottom wall portion 24 of the upper tubular portion 20 and the front end portion of the second top wall portion 34 of the lower tubular portion 30. However, a position of the connecting portion 40 in the vehicle front-rear direction is not limited to this. For example, the connecting portion 40 may connect respective rear end portions of the first bottom wall portion 24 and the second top wall portion 34 in the vehicle front-rear direction. The connecting portion 40 may connect respective middle portions of the first bottom wall portion 24 and the second top wall portion 34 in the vehicle front-rear direction.

According to the aforementioned embodiment, the bumper reinforcement 10 formed by bending the sheet of the belt-shaped metal plate along the longitudinal direction of the metal plate P and mounted to the vehicle body includes the upper tubular portion 20 formed in a tubular shape by bending the metal plate P along the longitudinal direction of the metal plate P, the lower tubular portion 30 formed in the tubular shape by bending the metal plate P along the longitudinal direction of the metal plate P, and the connecting portion 40, 40A, 40B, 40C formed by bending the middle portion in the width direction of the metal plate P along the longitudinal direction of the metal plate R The middle portion is positioned between portions where the upper tubular portion 20 and the lower tubular portion 30 are formed. The connecting portion 40, 40A, 40B, 40C connects the upper tubular portion 20 and the lower tubular portion 30 and includes the first folding portion (the upper-middle wall portion 52, the upper-rear wall portion 53, the upper-rear wall portion 51A, the upper-middle wall portion 52A, the upper-front wall portion 51B, the upper-middle wall portion 52B, the rear wall portion 41C and the middle wall portion 42C) sandwiching a first end portion 41 in the width direction of the metal plate P and the second folding portion (the lower-middle wall portion 62, the lower-rear wall portion 63, the lower-rear wall portion 61A, the lower-middle wall portion 62A, the lower-front wall portion 61B, the lower-middle wall portion 62B, the middle wall portion 42C and the front wall portion 43C) sandwiching a second end portion 42 in the width direction of the metal plate P.

According to the aforementioned disclosure, the first folding portion (the upper-middle wall portion 52, the upper-rear wall portion 53, the upper-rear wall portion 51A, the upper-middle wall portion 52A, the upper-front wall portion 51B, the upper-middle wall portion 52B, the rear wall portion 41C and the middle wall portion 42C) and the second folding portion (the lower-middle wall portion 62, the lower-rear wall portion 63, the lower-rear wall portion 61A, the lower-middle wall portion 62A, the lower-front wall portion 61B, the lower-middle wall portion 62B, the middle wall portion 42C and the front wall portion 43C) are positioned between the portions where the upper tubular portion 20 and the lower tubular portion 30 are formed. In other words, the upper tubular portion 20 is formed between the first end portion 41 of the metal plate P and the first folding portion (the upper-middle wall portion 52, the upper-rear wall portion 53, the upper-rear wall portion 51A, the upper-middle wall portion 52A, the upper-front wall portion 51B, the upper-middle wall portion 52B, the rear wall portion 41C and the middle wall portion 42C). The lower tubular portion 30 is formed between the second end portion 42 of the metal plate P and the second folding portion (the lower-middle wall portion 62, the lower-rear wall portion 63, the lower-rear wall portion 61A, the lower-middle wall portion 62A, the lower-front wall portion 61B, the lower-middle wall portion 62B, the middle wall portion 42C and the front wall portion 43C). The first end portion 41 of the metal plate P is sandwiched by the first folding portion (the upper-middle wall portion 52, the upper-rear wall portion 53, the upper-rear wall portion 51A, the upper-middle wall portion 52A, the upper-front wall portion 51B, the upper-middle wall portion 52B, the rear wall portion 41C and the middle wall portion 42C). The second end portion 42 of the metal plate P is sandwiched by the second folding portion (the lower-middle wall portion 62, the lower-rear wall portion 63, the lower-rear wall portion 61A, the lower-middle wall portion 62A, the lower-front wall portion 61B, the lower-middle wall portion 62B, the middle wall portion 42C and the front wall portion 43C). Accordingly, the upper tubular portion 20 and the lower tubular portion 30 are maintained to be formed in a tubular shape. Because the welding process performed to the known bumper reinforcement that needs the welding process is not needed, the production efficiency of the bumper reinforcement 10 is higher than the known bumper reinforcement that needs the welding process. Further, because the first end portion 41 of the metal plate P is sandwiched by the first folding portion (the upper-middle wall portion 52, the upper-rear wall portion 53, the upper-rear wall portion 51A, the upper-middle wall portion 52A, the upper-front wall portion 51B, the upper-middle wall portion 52B, the rear wall portion 41C and the middle wall portion 42C) while the second end portion 42 of the metal plate P is sandwiched by the second folding portion (the lower-middle wall portion 62, the lower-rear wall portion 63, the lower-rear wall portion 61A, the lower-middle wall portion 62A, the lower-front wall portion 61B, the lower-middle wall portion 62B, the middle wall portion 42C and the front wall portion 43C), the first end portion 41 and the second end portion 42 of the metal plate P are hardly separated from the first folding portion (the upper-middle wall portion 52, the upper-rear wall portion 53, the upper-rear wall portion 51A, the upper-middle wall portion 52A, the upper-front wall portion 51B, the upper-middle wall portion 52B, the rear wall portion 41C and the middle wall portion 42C) and the second folding portion (the lower-middle wall portion 62, the lower-rear wall portion 63, the lower-rear wall portion 61A, the lower-middle wall portion 62A, the lower-front wall portion 61B, the lower-middle wall portion 62B, the middle wall portion 42C and the front wall portion 43C), respectively, when the impact is applied to the bumper reinforcement 10. Thus, compared to the known bumper reinforcement, the collapse of the cross-section (the deformation of the cross-section) of the bumper reinforcement 10 in the collision of the vehicle is reduced. That is, according to the disclosure, the bumper reinforcement 10 has a higher strength than the known bumper reinforcement against the impact.

According to the aforementioned embodiment, the upper tubular portion 20, the lower tubular portion 30, the first folding portion (the upper-middle wall portion 52, the upper-rear wall portion 53, the upper-rear wall portion 51A, the upper-middle wall portion 52A, the upper-front wall portion 51B, the upper-middle wall portion 52B, the rear wall portion 41C and the middle wall portion 42C) and the second folding portion (the lower-middle wall portion 62, the lower-rear wall portion 63, the lower-rear wall portion 61A, the lower-middle wall portion 62A, the lower-front wall portion 61B, the lower-middle wall portion 62B, the middle wall portion 42C and the front wall portion 43C) are formed by roll-forming the metal plate P.

According to the aforementioned disclosure, the upper tubular portion 20, the lower tubular portion 30, the first folding portion (the upper-middle wall portion 52, the upper-rear wall portion 53, the upper-rear wall portion 51A, the upper-middle wall portion 52A, the upper-front wall portion 51B, the upper-middle wall portion 52B, the rear wall portion 41C and the middle wall portion 42C) and the second folding portion (the lower-middle wall portion 62, the lower-rear wall portion 63, the lower-rear wall portion 61A, the lower-middle wall portion 62A, the lower-front wall portion 61B, the lower-middle wall portion 62B, the middle wall portion 42C and the front wall portion 43C) may be integrally formed by roll-forming the belt-shaped metal plate P. Because roll-forming process refrains from increasing the number of the components, the bumper reinforcement 10 may be manufactured with a simple (easy) configuration.

According to the aforementioned embodiment, the first end portion 41 in the width direction of the metal plate P and the second end portion 42 in the width direction of the metal plate P are inserted to be positioned in the first folding portion (the upper-middle wall portion 52, the upper-rear wall portion 53, the upper-rear wall portion 51A, the upper-middle wall portion 52A, the upper-front wall portion 51B, the upper-middle wall portion 52B, the rear wall portion 41C and the middle wall portion 42C) and the second folding portion (the lower-middle wall portion 62, the lower-rear wall portion 63, the lower-rear wall portion 61A, the lower-middle wall portion 62A, the lower-front wall portion 61B, the lower-middle wall portion 62B, the middle wall portion 42C and the front wall portion 43C), respectively.

According to the aforementioned disclosure, the first end portion 41 and the second end portion 42 in the width direction of the metal plate P may be maintained by the first folding portion (the upper-middle wall portion 52, the upper-rear wall portion 53, the upper-rear wall portion 51A, the upper-middle wall portion 52A, the upper-front wall portion 51B, the upper-middle wall portion 52B, the rear wall portion 41C and the middle wall portion 42C) and the second folding portion (the lower-middle wall portion 62, the lower-rear wall portion 63, the lower-rear wall portion 61A, the lower-middle wall portion 62A, the lower-front wall portion 61B, the lower-middle wall portion 62B, the middle wall portion 42C and the front wall portion 43C), respectively. Because the welding process performed to the known bumper reinforcement that needs the welding process is not needed, the production efficiency of the bumper reinforcement 10 is increased.

According to the aforementioned embodiment, the first folding portion (the upper-middle wall portion 52, the upper-rear wall portion 53, the upper-rear wall portion 51A, the upper-middle wall portion 52A, the upper-front wall portion 51B, the upper-middle wall portion 52B, the rear wall portion 41C and the middle wall portion 42C) and the second folding portion (the lower-middle wall portion 62, the lower-rear wall portion 63, the lower-rear wall portion 61A, the lower-middle wall portion 62A, the lower-front wall portion 61B, the lower-middle wall portion 62B, the middle wall portion 42C and the front wall portion 43C) are deformed to be in close contact with the first end portion 41 in the width direction of the metal plate P and the second end portion 42 in the width direction of the metal plate P, respectively.

According to the aforementioned disclosure, the simple process of the deformation of the first folding portion (the upper-middle wall portion 52, the upper-rear wall portion 53, the upper-rear wall portion 51A, the upper-middle wall portion 52A, the upper-front wall portion 51B, the upper-middle wall portion 52B, the rear wall portion 41C and the middle wall portion 42C) and the second folding portion (the lower-middle wall portion 62, the lower-rear wall portion 63, the lower-rear wall portion 61A, the lower-middle wall portion 62A, the lower-front wall portion 61B, the lower-middle wall portion 62B, the middle wall portion 42C and the front wall portion 43C) are performed. Because the welding process performed to the known bumper reinforcement that needs the welding process is not needed, the production efficiency of the bumper reinforcement 10 is increased.

According to the aforementioned embodiment, the metal plate P has the yield strength of equal to or greater than 980 MPa and equal to or less than 1470 MPa.

According to the aforementioned disclosure, the effectiveness of the bumper reinforcement 10 that reduces the impact generated in the collision of the vehicle is maximized.

According to the aforementioned disclosure, the width direction of the metal plate P corresponds to the direction of the belt-shaped metal plate P perpendicular to the longitudinal direction.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fail within the spirit and scope of the present invention as defined in the claims, be embraced thereby.

1. A bumper reinforcement formed by bending a sheet of a belt-shaped metal plate along a longitudinal direction of the metal plate and mounted to a vehicle body, comprising:
a first tubular portion formed in a tubular shape by bending the metal plate along the longitudinal direction of the metal plate;
a second tubular portion formed in the tubular shape by bending the metal plate along the longitudinal direction of the metal plate; and
a connecting portion formed by bending a middle portion in a width direction of the metal plate along the longitudinal direction of the metal plate, the middle portion positioned between portions where the first tubular portion and the second tubular portion are formed, the connecting portion connecting the first tubular portion and the second tubular portion, wherein the connecting portion includes a first folding portion sandwiching a first end portion in the width direction of the metal plate and a second folding portion sandwiching a second end portion in the width direction of the metal plate.

2. The bumper reinforcement according to claim 1, wherein the first tubular portion, the second tubular portion, the first folding portion and the second folding portion are formed by roll-forming the metal plate.

3. The bumper reinforcement according to claim 1, wherein the first end portion in the width direction of the metal plate and the second end portion in the width direction of the metal plate are inserted to be positioned in the first folding portion and the second folding portion, respectively.

4. The bumper reinforcement according to claim 3, wherein the first folding portion and the second folding portion are deformed to be in close contact with the first end portion in the width direction of the metal plate and the second end portion in the width direction of the metal plate, respectively.

5. The bumper reinforcement according to claim 1, wherein the metal plate has a yield strength of equal to or greater than 980 MPa and equal to or less than 1470 MPa.
